(19) United States
(12) Patent Application Publication
(10) Pub. No.: US 2026/0288346 A1
(43) Pub. Date: Sep. 24, 2026

(54) MANAGING DATA RETENTION SCANS IN MEMORY SYSTEMS

(71) Applicant: Yangtze Memory Technologies Co., Ltd., Wuhan (CN)

(72) Inventors: He LIU, Wuhan (CN); Feiyang ZHANG, Wuhan (CN)

(21) Appl. No.: 19/180,066

(22) Filed: Apr. 15, 2025

(30) Foreign Application Priority Data
Mar. 19, 2025 (CN) 202510329042.8

(51) Int. Cl. G06F 3/06

(52) U.S. Cl. CPC G06F 3/0619; G06F 3/0659; G06F 3/0679

(57) ABSTRACT

Methods, devices, apparatuses, and systems for operating memory systems are provided. In one aspect, a memory system includes a memory device including a memory device and a memory controller coupled to the memory device. The memory controller is configured to scan the memory device at a first frequency, obtain an operation condition or a reliability performance of the memory device, and in response to determining that the operation condition or the reliability performance satisfies a criterion, scan the memory device at a frequency greater than the first frequency.

### CROSS-REFERENCE TO RELATED APPLICATIONS

This application claims priority to Chinese Patent Application No. 202510329042.8, filed on Mar. 19, 2025, which is hereby incorporated by reference in its entirety.

### TECHNICAL FIELD

The present disclosure generally relates to memory devices and memory systems, and in particular, to managing data retention scan in memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by a flash memory, for example, program (write) or read operations. Data retention scans can assess the reliability of the flash memory, e.g., by measuring how well data stored in the flash memory is retained over time.

### SUMMARY

The present disclosure involves methods, apparatuses, and systems for operating a memory system, e.g., managing data retention scans in the memory system.

One aspect of the present disclosure provides a memory system. The memory system includes a memory device and a memory controller coupled to the memory device. The memory controller is configured to scan the memory device at a first frequency, obtain an operation condition or a reliability performance of the memory device, and in response to determining that the operation condition or the reliability performance satisfies a criterion, scan the memory device at a frequency greater than the first frequency.

In some implementations, the memory controller is configured to scan the memory device at the first frequency by sending, at the first frequency, first read commands to read first data from the memory device, and determining whether the first data are read successfully.

In some implementations, the operation condition includes a system temperature of the memory system.

In some implementations, the system temperate is included in Self-Monitoring, Analysis and Reporting Technology (SMART) information of the memory system.

In some implementations, the operation condition further includes a speed of data transmission between a host and the memory controller. The memory controller is configured to, in response to determining that the system temperature is greater than a first threshold and the speed of data transmission is less than a second threshold, scan the memory device at a second frequency. The second frequency is greater than the first frequency.

In some implementations, the speed of data transmission is included in SMART information of the memory system

In some implementations, the memory controller is configured to, in response to determining that the system temperature is less than the first threshold or the speed of data transmission is greater than the second threshold, scan the memory device at the first frequency.

In some implementations, the memory device includes a plurality of memory blocks. The reliability performance includes a count of consecutive memory blocks which are scanned consecutively and on which garbage collection is performed. The memory controller is configured to, in response to determining that the count of consecutive memory blocks is greater than a third threshold, scan the memory device at a third frequency, wherein the third frequency is greater than the first frequency.

In some implementations, the memory controller is configured to receive a response corresponding to a scan result of scanning a memory block, and determine whether the memory block needs garbage collection based on the response.

In some implementations, the response includes a failed bit count of the memory block.

In some implementations, the garbage collection is performed while there is no data transmission between a host and the memory controller.

In some implementations, the memory controller is configured to, in response to determining that each of the plurality of memory blocks is scanned, scan the memory device at the first frequency.

Another aspect of the present disclosure features a method of operating a memory system. The method includes scanning a memory device of the memory system at a first frequency, obtaining an operation condition or a reliability performance of the memory device, and in response to determining that the operation condition or the reliability performance satisfies a criterion, scanning the memory device at a frequency greater than the first frequency.

In some implementations, scanning the memory device at the first frequency includes sending, at the first frequency, first read commands to read first data from the memory device, and determining whether the first data are read successfully.

In some implementations, the operation condition comprises a system temperature of the memory system and a speed of data transmission between a host and the memory system. The method includes, in response to determining that the system temperature is greater than a first threshold and the speed of data transmission is less than a second threshold, scanning the memory device at a second frequency. The second frequency is greater than the first frequency.

In some implementations, the memory device includes a plurality of memory blocks. The reliability performance includes a count of consecutive memory blocks which are scanned consecutively and on which garbage collection is performed. The method includes, in response to determining that the count of consecutive memory blocks is greater than a third threshold, scanning the memory device at a third frequency, wherein the third frequency is greater than the first frequency.

A further aspect of the present disclosure features a memory controller. The memory controller includes one or more processors and an interface. The one or more processors are configured to send, by the interface to a memory device coupled to the memory controller, first read commands at a first frequency to scan the memory device, obtain an operation condition or a reliability performance of the memory device, and in response to determining that the operation condition or the reliability performance satisfies a criterion, send, by the interface to the memory device, second read commands at a second frequency to scan the memory device, wherein the second frequency is greater than the first frequency.

In some implementations, the operation condition includes a system temperature of a memory system comprising the memory controller and the memory device, and a speed of data transmission between a host and the memory controller. The memory controller is configured to, in response to determining that the system temperature is greater than a first threshold and the speed of data transmission is less than a second threshold, send the second read commands at the second frequency.

In some implementations, the memory controller is configured to, in response to determining that the system temperature is less than the first threshold or the speed of data transmission is greater than the second threshold, send the first read commands at the first frequency.

In some implementations, the memory device comprises a plurality of memory blocks. The reliability performance includes a count of consecutive memory blocks which are scanned consecutively and on which garbage collection is performed. The memory controller is configured to, in response to determining that the count of consecutive memory blocks is greater than a third threshold, send third read command at a third frequency to scan the memory device, wherein the third frequency is greater than the first frequency.

An additional aspect of the present disclosure features a non-transitory, computer-readable medium. The non-transitory, computer-readable medium stores one or more instructions executable by a memory system to perform operations including, scanning a memory device of the memory system at a first frequency, obtaining an operation condition or a reliability performance of the memory device, and in response to determining that the operation condition or the reliability performance satisfies a criterion, scanning the memory device at a frequency greater than the first frequency.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device.

FIGS. 2A-2B illustrate example storage products.

FIG. 3 illustrates an example of a schematic diagram of an example memory device.

FIG. 4 illustrates some example peripheral circuits.

FIG. 5A illustrates a block diagram of an example memory system including an example memory controller.

FIG. 5B illustrates a block diagram of an example memory controller.

FIG. 6 illustrates a flow chart of an example process of managing data retention scans in a memory system.

FIG. 7 illustrates a swimlane diagram of an example process to manage data retention scans in a memory system.

FIG. 8 illustrates a flow chart of an example method of operating a memory system.

Like reference numbers and designations in the various drawings indicate like elements.

### DETAILED DESCRIPTION

This present disclosure relates to memory devices, memory systems, and methods for managing data retention scans. Data retention scans can measure how well data stored in a memory device is retained over time. For example, a memory controller can send read commands to read data from the memory device, and determine if the data can be successfully read. If the data contains errors, the memory controller can correct the error and/or perform garbage collection to move the data to a new memory block, so that there can be fewer errors when a host reads data from the memory device.

In some cases, when performing the data retention scan, the memory controller scans the memory device at a fixed frequency, e.g., targets to complete scanning all memory blocks in the memory device within a scan duration. However, scanning the memory device at a fixed frequency may fail to take into account environmental factors (e.g., temperature, which may impact data retention performance of the memory device) and condition of the memory device (e.g., data reliability such as error rates). As such, under certain circumstances, there may be excessive read retries, which may lead to long read latencies, and/or excessive uncorrectable error correction code (UECC) errors.

In some cases, some manufacturers reduce the scan duration to mitigate the problem of excessively high error rate caused by long exposure to a high-temperature environment. However, by scanning the memory device at a fixed high frequency, the frequency of accessing the memory device due to data retention scan may be high, which may impact foreground tasks such as host read/write operations.

Implementations of the present disclosure provide techniques to manage data retention scans in memory systems. The memory system can adjust the frequency of scanning the memory device based on an operation condition (e.g., temperature and/or a speed of data transmission between the host and the memory controller) and/or a reliability performance (e.g., a count of consecutive memory blocks that need garbage collection) of the memory device. In some implementations, a memory controller can, by default, scan the memory device at a first frequency. In response to determining that the operation condition or the reliability performance satisfies a criterion, the memory controller scans the memory device at a frequency greater than the first frequency. For example, if the system temperature is greater than a first threshold and the speed of data transmission between a host and the memory controller is less than a second threshold, the memory controller can scan the memory device at a second frequency greater than the first frequency. In some implementations, if the count of consecutive memory blocks that need garbage collection is greater than a third threshold (which may indicate that an overall error rate of data in the memory device is high), the memory controller can scan the memory device at a third frequency greater than the first frequency and the second frequency.

The described techniques can achieve one or more technical effects (e.g., technical advantages and/or benefits). For example, by increasing the scan frequency when the system temperature is high, memory blocks can be scanned within a shorter duration to prevent further data loss, so that the amount of read retries and uncorrectable read errors can be reduced. For another example, by keeping the scan frequency at a lower frequency when the speed of data transmission between the host and the memory controller is high, the data retention scan can have a reduced impact on foreground tasks. Further, in some implementations, the described techniques can be implemented as software or firmware, without requiring hardware changes in the memory controller, which is cost-effective. In some implementations, additional or different technical effects can be achieved.

The techniques can be applied to various types of semiconductor devices, e.g., non-volatile memory (NVM) devices (such as NAND flash memory or NOR flash memory), volatile memory devices (such as DRAM memory devices), resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to three-dimensional (3D) memory devices. The techniques can be applied to various memory types, such as SLC (single-level cell) devices, MLC (multi-level cell) devices like 2-level cell devices, TLC (triple-level cell) devices, QLC (quad-level cell) devices, or PLC (penta-level cell) devices. Additionally or alternatively, the techniques can be applied to various types of devices and systems, such as secure digital (SD) cards, embedded multimedia cards (eMMC), universal flash storage (UFS), or solid-state drives (SSDs), embedded systems, among others.

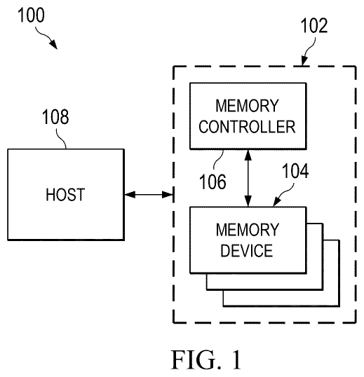

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random-access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device by one or more interfaces by at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

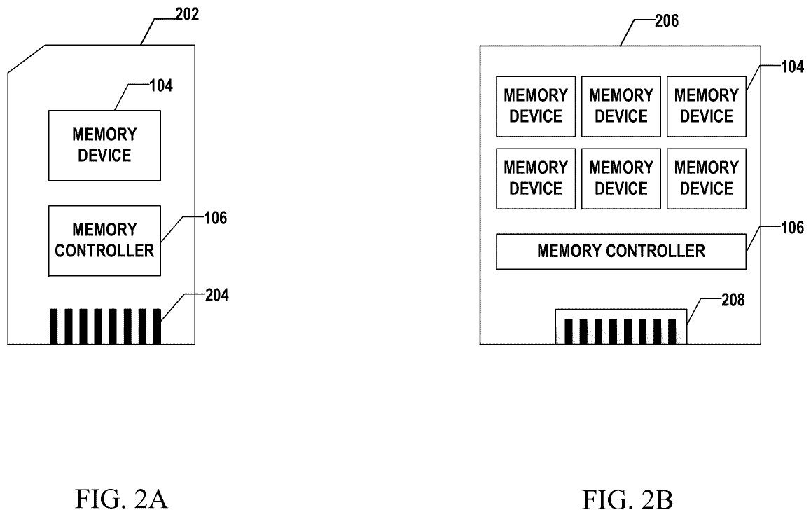

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

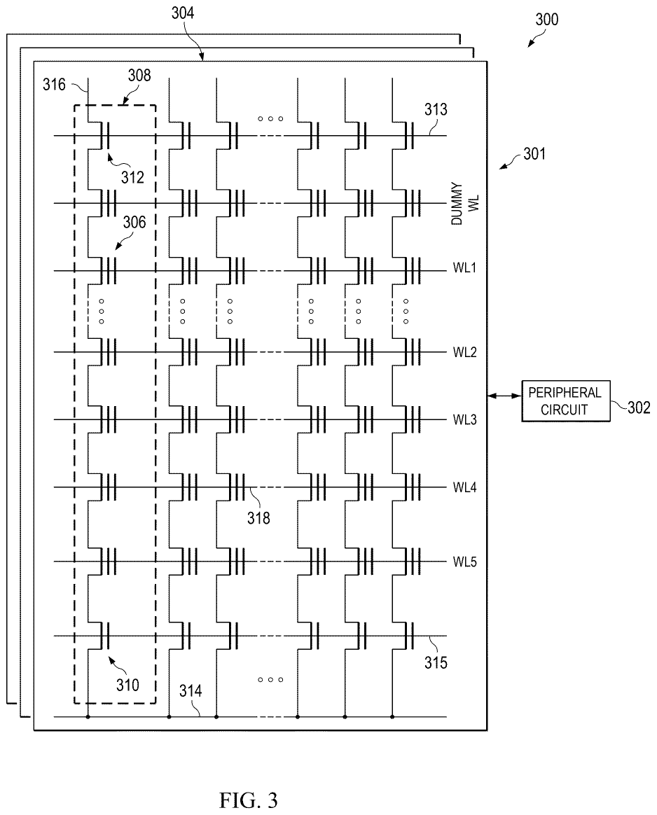

FIG. 3 illustrates an example of a schematic diagram of a memory device 300 including peripheral circuits, according to some aspects of the present disclosure. The memory device 300 can include a memory cell array 301 and peripheral circuits 302 coupled to the memory cell array 301. The memory cell array 301 can include a plurality of memory blocks 304. The memory cell array 301 can be a NAND Flash memory cell array in which memory cells 306 are provided in the form of an array of memory strings 308 each extending vertically above a substrate (not shown in FIG. 3). In some implementations, each memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each memory string 308 can include a source select gate (SSG) 310 at its source end and a drain select gate (DSG) 312 at its drain end. The SSG 310 and the DSG 312 can be configured to activate selected memory strings 308 (columns of the array) during read and program operations. In some implementations, the sources of memory strings 308 in the same memory block 304 are coupled through a same source line (SL) 314, e.g., a common SL. In other words, memory strings 308 in the same memory block 304 have an array common source (ACS), according to some implementations. The DSG 312 of each memory string 308 is coupled to a respective bit line 316 from which data can be read or written via an output bus (not shown), according to some implementations. In some implementations, each memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 are between one or more DSG lines 313 and one or more SSG lines 315.

In some implementations, the memory cells 306 of adjacent memory strings 308 can be coupled through word lines 318. The word line 318 can select which row of memory cells 306 is affected by read and program operations. In some implementations where memory cells 306 are SLCs, one row of memory cells 306 can store one logical page of data, and therefore corresponds to one logical page. In some implementations where memory cells 306 are MLCs, one row of memory cells 306 can store two logical pages of data, and therefore corresponds to two logical pages. In some implementations where memory cells 306 are TLCs, one row of memory cells 306 can store three logical pages of data, and therefore corresponds to three logical pages. In some implementations where memory cells 306 are QLCs, one row of memory cells 306 can store four logical pages of data, and therefore corresponds to four logical pages.

Each word line 318 can include a gate line coupled to a plurality of control gates (gate electrodes) of a plurality of memory cells 306. Example word lines shown in FIG. 3 include WL0, WL1, . . . , WLn−2, WLn−1, and WLn that are between DSG line 313 and SSG line 315. In some implementations, the word lines can further include dummy word lines coupled to dummy memory cells.

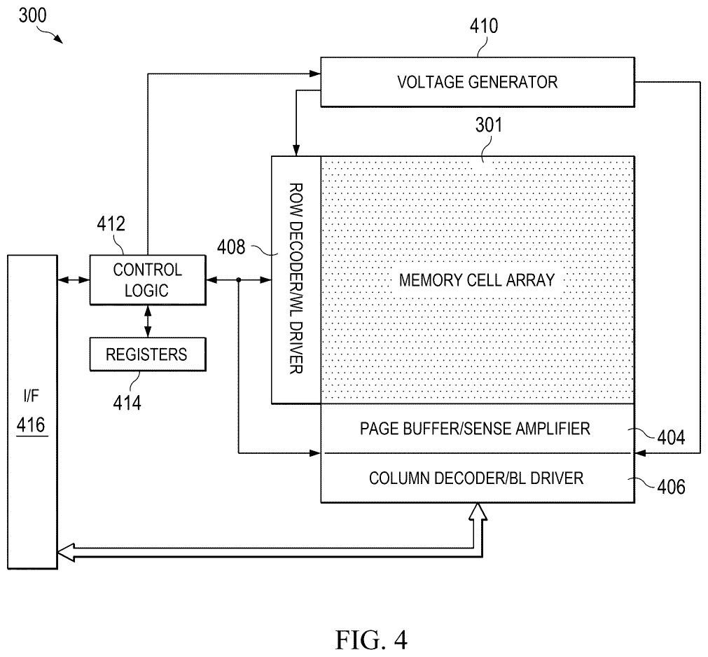

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into the memory cell array 301. In another example, the page buffer/sense amplifier 404 may perform program verify operations to ensure that the data have been properly programmed into memory cells 306 coupled to selected word lines 318. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 318 of the memory block 304. The row decoder/word line driver 408 can be further configured to drive word lines 318 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 318 in a program operation on memory cell 306 coupled to selected word line 318.

The voltage generator 410 can be configured to be controlled by the control logic 412 and generate the word line voltages (e.g., read reference voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

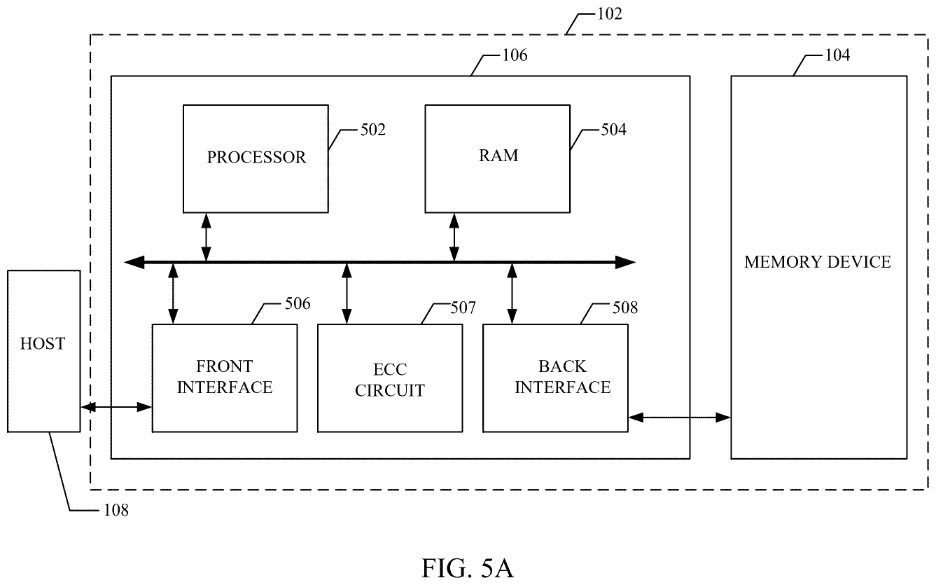

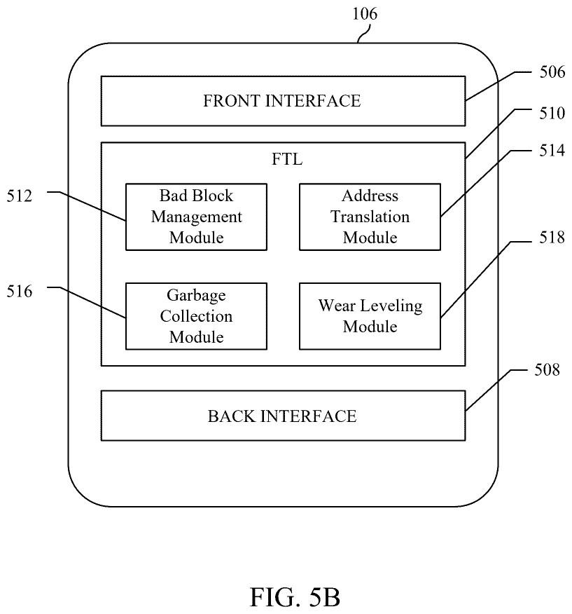

FIG. 5A is a block diagram of an example memory system 102 including an example memory controller 106. The memory system 102 further includes a memory device 104. The memory system can be coupled to a host 108.

The memory controller 106 is configured to operate the memory device 104 at the request of the host 108. The memory controller 106 is configured to drive firmware for controlling the operations of the memory device 104. The memory controller 106 can include a random access memory (RAM) 504, a processor 502, a front interface 506, an error-correction code (ECC) circuit 507, and a back interface 508.

The memory controller 106 is configured to communicate with the host 108 through the front interface 506. For example, the memory controller 106 can receive commands from the host 108 and send responses to the host 108 through the front interface 506. The memory controller 106 is configured to communicate with the memory device 104 through the back interface 508. For example, the memory controller 106 can send commands to the memory device 104 and receive responses from the memory device 104 through the back interface 508. The back interface 508 may include a NAND flash interface or a NOR flash interface.

The ECC circuit 507 is configured to process error correction codes with respect to the data read from or written to the memory device 104. Example error correction codes can include, but are not limited to, Hamming codes, Reed-Solomon codes, low-density parity check (LDPC) codes, etc. In some implementations, the ECC circuit 507 includes an LPDC encoder configured to generate parity data based on LDPC codes for user data received from the host 108, so that both the user data and the parity data can be sent to the memory device 104 for storage. The ECC circuit 507 can further include an LDPC decoder configured to decode data comprising the user data and the parity data. The ECC circuit can determine whether data stored in the block is read successfully (e.g., with no errors). If the data contains errors, the ECC circuit 507 can correct the error based on the ECC codes (e.g., by using the parity data). In some cases, if the ECC circuit 507 successfully corrects errors within its correction capability, the read operation to read the data is considered successful. If the data stored in the block is read successfully, the back interface 508 can forward the data to the front interface 506, so that the front interface 506 can return the data to the host 108. However, if the data stored in the memory block is not read successfully (e.g., the number of error bits exceeds the correction capacity of the ECC circuit 507), the back interface 508 can generate data describing a read error on the memory block, for example, send an uncorrectable error correction code (UECC) response to the host 108.

The RAM 504 is configured to be used as an operation memory of the processor 502, a cache memory between the memory device 104 and the host 108, and/or a buffer memory between the memory device 104 and the host 108.

The processor 502 is configured to control operations of the memory controller 106. The processor 502 is configured to control a read operation, a program operation, an erase operation, or other operations of the memory device 104. In some implementations, the processor 502 can function as a flash translation layer (FTL) 510.

As shown in FIG. 5B, the FTL 510 can include a bad block management module 512, an address translation module 514, a garbage collection (GC) module 516, and a wear leveling module 518. In some implementations, the FTL 510 can include other modules not shown in FIG. 5B.

The bad block management module 512 can be configured to identify failed memory blocks (e.g., by maintaining a bad block table) in the memory device 104. In some implementations, a memory block (e.g., memory block 304 of FIG. 3) may fail due to various factors including manufacturing defects, wear from repeated use, or physical damage. A failed memory block can be skipped or replaced in read or program operations to prevent data corruption.

The address translation module 514 can be configured to translate or map logical data blocks (e.g., received from the host 108) to physical spaces in the memory device 104. In some implementations, the address translation module 514 can translate a logical block address (LBA) provided by the host 108 into a physical block address (PBA) based on a logical to physical (L2P) mapping table. There may be various address mapping methods for the address translation module 514. Examples of address mapping methods include a page mapping method, a block mapping method, and a hybrid mapping method.

The GC module 516 can be configured to migrate data from a source memory block to a target memory block, so that the source memory block can be erased to be available for writing new data. For example, the GC module 516 can be configured to select a source memory block and a target memory block in the memory device 104, read valid data from the source memory block by sending read commands to the memory device 104, write the valid data to the target memory block by sending write commands to the memory device 104, and then erase the source memory block. In some implementations, the GC module 516 can be configured to perform foreground garbage collection on the memory device 104, where the garbage collection is performed when there are not enough memory blocks available for writing new data. In some implementations, the GC module 516 can perform background garbage collection on the memory device 104, where the garbage collection is performed while the memory system 102 is idle (e.g., when there is no data transmission between the host 108 and the memory controller 106). For example, if a failed bit count (FBC) of a memory block exceeds a threshold, the memory controller can determine that the memory block needs garbage collection. For example, the memory controller can add an identifier of the memory block to a pending queue, and perform garbage collection on memory blocks recorded in the pending queue (e.g., according to a sequence of the memory blocks in the pending queue) while the memory system 102 is idle.

The wear leveling module 518 can be configured to balance E/P cycles across memory blocks. For example, the wear leveling module 518 can track the E/P cycle count of each memory block, and write new data to the least-used memory block first. For another example, the wear leveling module 518 can move cold data (data that are not frequently accessed) to another memory block to ensure that different memory blocks wear out at similar rates.

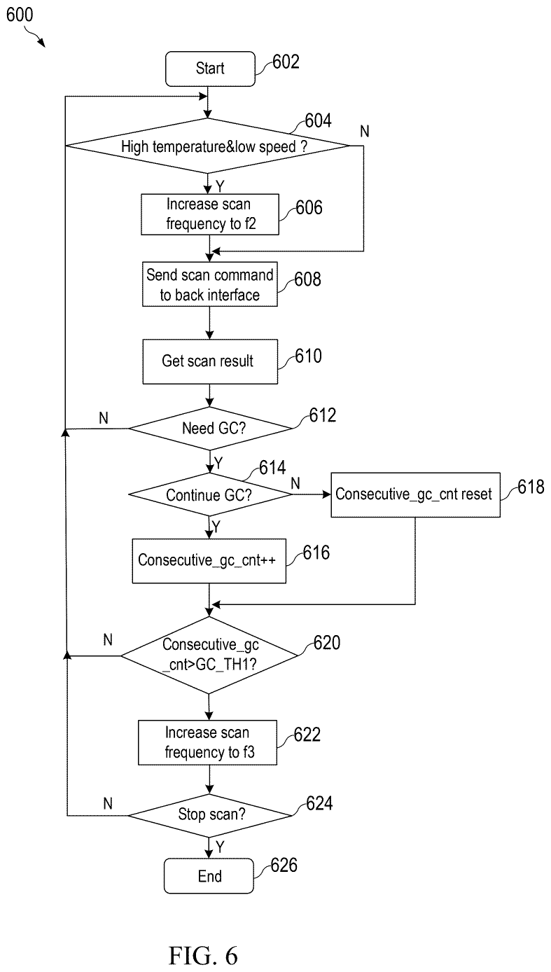

FIG. 6 illustrates a flow chart of an example process 600 of managing data retention scans in a memory system (e.g., memory system 102 of FIGS. 1 and 5A). Data retention scans can measure how well data stored in the memory device of the memory system is retained over time, for example, by sending read commands to the memory device to read data from the memory device, and determining whether the data are read successfully. For example, an ECC circuit (e.g., ECC circuit 507 of FIG. 5A) can determine a failed bit count (FBC) in a memory page or a memory block being read as an indicator of how well data in the memory page or the memory block is retained. If a memory block being read has an FBC greater than a threshold, the memory block can be considered unreliable, and the memory controller can perform garbage collection on the memory block to prevent further data loss. As such, data retention scans can assess and improve the reliability of the memory system.

In some implementations, the memory controller can perform data retention scans at different frequencies. For example, under a default setting, the memory controller performs one round of data retention scan (e.g., by scanning all memory blocks of the memory device) within T1 days (e.g., 30 days, or any suitable amount of time). To achieve this, the memory controller can send a read command to read data from a memory page every X seconds, and determine whether the data in the memory page contains error(s). In some implementations, the memory controller can increase the frequency of data retention scan in response to detecting a specific operation condition (e.g., a system temperate of the memory system exceeds a threshold temperature) or a reliable performance (e.g., the number of unreliable memory blocks exceeds a threshold) of the memory device. For example, the memory controller can send a read command to read data from a memory page every Y seconds (Y<X), which is equivalent to performing one round of data retention scan within T2 days (e.g., 7 days, or any suitable amount of time).

The example process 600 can be performed by a memory system (e.g., the memory system 102 of FIG. 1) coupled to a host (e.g., the host 108 of FIGS. 1 and 5A). The memory system can include a memory controller (e.g., the memory controller 106 of FIGS. 1-2B and 5A-5B) and a memory device (e.g., the memory device 104 of FIG. 1-2B and 5A, and the memory device 300 of FIGS. 3-4) including memory blocks (e.g., memory blocks 304 of FIG. 3). The operations shown in process 600 may not be exhaustive and that other operations can be performed as well before, after, or in between any of the illustrated operations. Further, some of the operations may be performed simultaneously, or in a different order than shown in FIG. 6. In some implementations, some of the operations may be performed by or one or more components of a device or a system, such as, a memory controller, or a peripheral circuit of the memory device.

Process 600 starts at 602. In some implementations, by default, the memory controller can scan the memory device at a first frequency, e.g., by sending read commands to read data from the memory device at the first frequency.

At 604, the memory controller obtains an operation condition of the memory device, and determines whether the operation condition of the memory device satisfies a criterion. For example, the operation condition can include one or more of: a system temperature, a speed of data transmission between the memory controller and the host, an operation mode of the memory system (e.g., low-power mode, or high-power mode), etc.

In some implementations, the system temperature can represent a current temperature of the memory system. For example, the system temperature can be an average, a weighted average, or another temperature fitted based on some or all of the temperatures received from temperature sensors located in the memory device and the memory controller. In some implementations, the system temperature is included in the Self-Monitoring, Analysis and Reporting Technology (SMART) information of the memory system. The SMART information can report various indicators (e.g., current temperature, power cycles, power-on hours, media errors) that may have impact on the reliability of the memory system to a user. In some implementations, the speed of data transmission between the host and the memory controller can also be included in the SMART information.

If the memory controller determines that the operation condition satisfies a criterion, the process 600 proceeds to 606 to increase the scan frequency. If not, the process 600 skips 606, and continues to scan the memory device at the first frequency.

For example, the memory controller can obtain the system temperature (e.g., by accessing the SMART information), and determine whether the system temperature is greater than a first threshold (e.g., 80° C., or any suitable temperature). If the system temperature is greater than the first threshold, it indicates that memory cells in the memory device are more likely to lose electrons due to the high temperature, and therefore the data retention performance of the memory device may decrease more rapidly. As such, the process 600 proceeds to 606, where the memory controller scans the memory device at an increased frequency (e.g., at the second frequency greater than the first frequency), so that all memory blocks in the memory device can be scanned within a shorter period. If the scan frequency remains at the first frequency, memory blocks that are scanned later may experience aggravated data loss (e.g., resulting in uncorrelatable errors) due to being in the high-temperature environment for a long time.

For another example, the memory controller can obtain both the system temperature and the speed of data transmission between the host and the memory controller, and determine whether the system temperature is greater than the first threshold, and whether the speed of data transmission is lower than a second threshold. If the system temperature is greater than the first threshold and the speed of data transmission is less than the second threshold, the process 600 proceeds to 606, where the memory controller can increase the scan frequency to the second frequency. If the system temperature is greater than the first threshold and the speed of data transmission is greater than the second threshold, it indicates that the host may be performing a performance test on the memory system by intensively sending commands and data to the memory system. The memory controller can keep the scan frequency at the first frequency, without increasing the scan frequency to interrupt the performance test.

At 606, the memory controller increases the scan frequency to the second frequency, and scans the memory device at the second frequency.

In some implementations, while the memory controller scans the memory device at the second frequency, if the memory controller determines that the operation condition no longer satisfies the criterion (e.g., the system temperature is less than the first threshold, and/or the speed of data transmission is greater than the second threshold), the memory controller can decrease the scan frequency to the first frequency.

At 608, the memory controller (e.g., processor 502 of the memory controller 106 of IFG>5A) can send a scan command indicating to scan the memory device at the second frequency. The scan command can be sent to a back interface (e.g., back interface 508 of FIGS. 5A-5B) of the memory controller. In response to receiving the scan command, the back interface can send read commands to the memory device at an increased frequency. For example, each read command indicates to read data from a memory page of the memory device.

At 610, in response to receiving the data from the memory device, the memory controller (e.g., by the ECC circuit 507 of FIG. 5A) can determine a scan result. The back interface of the memory controller can send a response indicating the scan result, e.g., to the processor of the memory controller so that the memory controller can perform garbage collection. In some implementations, the scan result of scanning a memory block can include a failed bit count (FBC) in the memory block. For example, the memory controller can determine an FBC of a memory block by reading all memory pages in the memory block. For another example, the memory controller can determine an FBC of a memory block by reading selected memory pages in the memory block.

At 612, the memory controller determines whether the memory block needs garbage collection based on the scanning result of scanning the memory device. For example, if the FBC of the memory block exceeds a threshold, the memory controller determines that the memory block needs garbage collection. In some implementations, the memory controller can add the identifier of the memory block to a queue, and perform garbage collection on the memory block while the memory system is idle (e.g., while there is no data transmission between the host and the memory controller).

At 614, the memory controller scans the next memory block, and determines whether the next memory block needs garbage collection based on the scanning result of scanning the next memory block. If the memory controller determines that the next memory block also needs garbage collection, the process 600 proceeds to 616, where a count of consecutive memory blocks that need garbage collection is increased by one. If not, the process proceeds to 618, where the count of consecutive memory blocks that need garbage collection is reset to zero. The count of consecutive memory blocks that need garbage collection can refer to a quantity of memory blocks which are scanned consecutively during one round of data retention scan, and on which garbage collection needs to be performed based on the scanning results. The count of consecutive memory blocks that need garbage collection can therefore be used as a metric indicating a reliability performance of the memory device. For example, if the count of consecutive memory blocks that need garbage collection is high, it indicates that data may not be securely retained in the memory device overall, such that the reliability of the memory device is decreased.

At 620, the memory controller obtains a reliability performance of the memory device, and determines whether the reliability performance of the memory device satisfies a criterion. For example, the reliability performance of the memory device can include one or more of: the count of consecutive memory blocks that need garbage collection, erase/program cycle status of the memory device, read retry count, uncorrectable bit error rate, latency of read operation, etc.

If the memory controller determines that the reliability performance satisfies a criterion, the process 600 proceeds to 622 to increase the scan frequency. If not, the process 600 proceeds to 604, where the memory controller continues to scan the memory device at the first frequency.

In some implementations, the memory controller obtains the count of consecutive memory blocks that need garbage collection as a metric of reliability performance, and determines whether the count of consecutive memory blocks that need garbage collection is greater than a third threshold (e.g., eight, sixteen, or other suitable number). If the count of consecutive memory blocks that need garbage collection is greater than the third threshold, the process 600 proceeds to 622, where the scan frequency is increased to a third frequency. The third frequency is greater than the first frequency. In some implementations, the third frequency can be greater than the second frequency.

In some implementations, to increase the scan frequency to the third frequency, the memory controller can send a scan command indicating to scan the memory device at the third frequency to the back interface of the memory controller. In response to receiving the scan command, the back interface can send read commands to the memory device at an increased frequency.

In some implementations, the memory controller scans the memory device at the third frequency until one round of data retention scan is completed (e.g., all memory blocks in the memory device are scanned). In response to determining that each one of all the memory blocks is scanned, the memory controller can start a new round of data retention scan, and execute the process 600 again during the new round of data retention scan.

At 624, the memory controller determines whether the data retention scan can end. If so the process 600 ends at 626. If not, the process 600 proceeds to 604. For example, in response to receiving a command from the host, the memory controller can end the data retention scan. For another example, if one round of data retention scan is completed, that is, all memory blocks of the memory block have been scanned, the memory controller can end the data retention scan. In some implementations, if one round of data retention scan is completed, the memory controller may stop scanning the memory device for a while, until the next scan command is received.

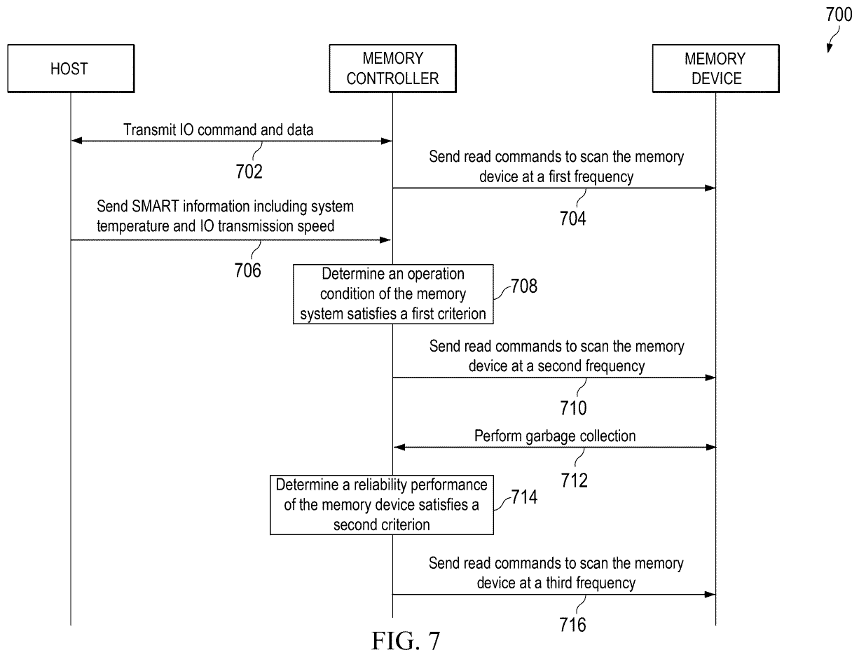

FIG. 7 illustrates a swimlane diagram of an example process 700 to manage data retention scans in a memory system. The example process 700 can be performed by a memory system (e.g., the memory system 102 of FIGS. 1 and 5A) coupled to a host (e.g., the host 108 of FIGS. 1 and 5A). The memory system can include a memory controller (e.g., the memory controller 106 of FIGS. 1-2B and 5A-5B) and a memory device (e.g., the memory device 104 of FIG. 1-2B and 5A, and the memory device 300 of FIGS. 3-4) including a plurality of memory blocks (e.g., memory blocks 304 of FIG. 3).

The operations shown in process 700 may not be exhaustive and other operations can be performed as well before, after, or in between any of the illustrated operations. Further, some of the operations may be performed simultaneously, or in a different order than shown in FIG. 7. In some implementations, some of the operations may be performed by or one or more components of a device or a system, such as, a memory controller, or a peripheral circuit of the memory device.

At 702, input/output (IO) commands and data are transmitted between the host and the memory controller. For example, the IO commands can include read commands, write commands, erase commands, etc. The data can include host data to be written to the memory device, and/or data read from the memory device. In some implementations, a speed of data transmission between the host and the memory controller (e.g., also referred to as IO transmission speed) can be measured and included in the SMART information of the memory system. The SMART information can further include a system temperature of the memory system.

At 704, the memory controller sends first read commands to scan the memory device at first frequency. The first read commands can indicate to read data from certain memory pages or memory blocks of the memory device. In response to receiving the first read commands, the memory device can send data to the memory controller, so that the memory controller can determine an FBC of the data being read (e.g., by an ECC circuit of the memory controller).

At 706, the host sends the system temperature and/or the speed of data transmission to the memory controller. The system temperature and the speed of data transmission can be included in the SMART information of the memory system.

At 708, the memory controller determines that an operation condition of the memory device satisfies a first criterion. For example, if the system temperature is greater than a first threshold and the speed of data transmission is less than a second threshold, the memory controller determines that the operation condition satisfies the first criterion. If the memory temperature is less than the first threshold, the memory controller can continue to scan the memory device at the first frequency. If the memory temperature is greater than the first threshold and the speed of data transmission is greater than the second threshold, the memory controller may deem that the memory system is under a performance test, and the memory controller can continue to scan the memory device at the first frequency, without increasing the scan frequency to disturb the performance test.

At 710, the memory controller sends second read commands to scan the memory device at a second frequency greater than the first frequency. Similar to the first read commands sent at 704, the second read commands can indicate to read data from certain memory pages or memory blocks of the memory device. In response to receiving the second read commands, the memory device can send data to the memory controller, so that the memory controller can determine an FBC of the data being read.

At 712, the memory controller determines whether to perform garbage collection on a memory block based on a scanning result of scanning the memory block. For example, if an FBC of the memory block is greater than a pre-set threshold, the memory controller can determine the memory block needs garbage collection to prevent further data loss. Further, the memory controller can perform garbage collection on the memory block by sending read commands to read valid data from the memory block, sending write commands to write the valid data to another memory block, and sending erase commands to erase the memory block.

At 714, the memory controller determines that a reliability performance of the memory device satisfies a second criterion. For example, if a count of consecutive memory blocks that need garbage collection is greater than a third threshold, the memory controller determines that the reliability performance satisfies the second criterion.

At 716, the memory controller sends third read commands to scan the memory device at a third frequency greater than the first frequency and second frequency. Similar to the first read commands and the second read commands, the third read commands can indicate to read data from certain memory pages or memory blocks of the memory device. In response to receiving the third read commands, the memory device can send data to the memory controller, so that the memory controller can determine an FBC of the data being read.

In some implementations, after completing one round of data retention scan, the memory controller can start a new round of data retention scan at the first frequency, and determine whether to increase the scan frequency based on the operation condition and/or the reliability performance.

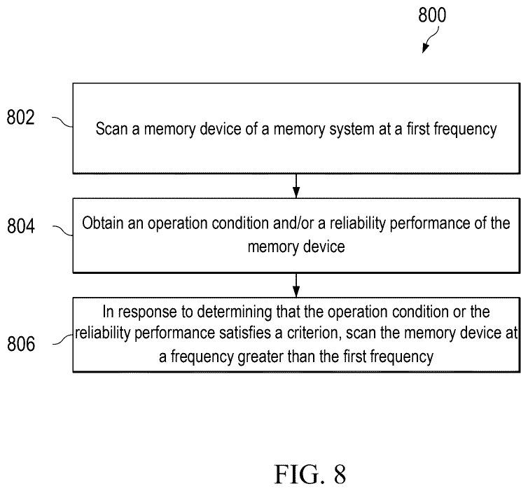

FIG. 8 illustrates a flow chart of an example method 800 of operating a memory system. The method 800 can be performed by a memory system (e.g., the memory system 102 of FIGS. 1 and 5A) coupled to a host (e.g., the host 108 of FIGS. 1 and 5A). The memory system can include a memory controller (e.g., the memory controller 106 of FIGS. 1-2B and 5A-5B) and a memory device (e.g., the memory device 104 of FIG. 1-2B and 5A, and the memory device 300 of FIGS. 3-4) including a plurality of memory blocks (e.g., memory blocks 304 of FIG. 3).

The operations shown in method 800 may not be exhaustive and other operations can be performed as well before, after, or in between any of the illustrated operations. Further, some of the operations may be performed simultaneously, or in a different order than shown in FIG. 8. In some implementations, some of the operations may be performed by or one or more components of a device or a system, such as, a memory controller, or a peripheral circuit of the memory device.

At 802, the memory controller scans the memory device at a first frequency. In some implementations, the memory controller sends read commands to the memory device at the first frequency, and determines whether the data can be successfully read.

At 804, the memory controller obtains an operation condition and/or a reliability performance of the memory device. In some implementations, the operation condition can include, for example, a system temperature of the memory system, and a speed of data transmission between the host and the memory controller. The reliability performance can include, for example, a count of memory blocks which are scanned consecutively and on which garbage collection is performed (or needs to be performed).

At 806, in response to determining that the operation condition and/or the reliability performance satisfies a respective criterion, the memory controller scans the memory device at a frequency greater than the first frequency. In some implementations, if the system temperature is greater than a first threshold and the speed of data transmission is less than a second threshold, the memory controller can scan the memory device at a second frequency greater than the first frequency. In some implementations, if the count of consecutive memory blocks that need garbage collection is greater than a third threshold, the memory controller can scan the memory device at a third frequency greater than the first frequency and the second frequency.

The present disclosure also provides a non-transitory computer-readable storage medium. The non-transitory computer-readable storage medium stores one or more instructions (e.g., firmware code of a memory system) that are executable by a processor of a controller and/or a peripheral circuit of a memory device. When being executed by the processor of the controller and/or the peripheral circuit of the memory device, the instructions in the storage medium can implement the method for managing data retention scans in a memory system, as shown in FIGS. 1-8.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device. In some implementations, the firmware code of the memory system can be stored in a storage medium (e.g., a DRAM coupled to the controller) of the controller, or in a memory array (e.g., a NAND memory array) of the memory device.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A memory system, comprising:
a memory device; and
a memory controller coupled to the memory device and configured to:
scan the memory device at a first frequency;
obtain an operation condition or a reliability performance of the memory device; and
in response to determining that the operation condition or the reliability performance satisfies a criterion, scan the memory device at a frequency greater than the first frequency.

2. The memory system of claim 1, wherein the memory controller is configured to scan the memory device at the first frequency by:
sending, at the first frequency, first read commands to read first data from the memory device; and
determining whether the first data are read successfully.

3. The memory system of claim 1, wherein the operation condition comprises a system temperature of the memory system.

4. The memory system of claim 3, wherein the system temperate is included in Self-Monitoring, Analysis and Reporting Technology (SMART) information of the memory system.

5. The memory system of claim 3, wherein the operation condition further comprises a speed of data transmission between a host and the memory controller,
wherein the memory controller is configured to:
in response to determining that the system temperature is greater than a first threshold and the speed of data transmission is less than a second threshold, scan the memory device at a second frequency, wherein the second frequency is greater than the first frequency.

6. The memory system of claim 5, wherein the speed of data transmission is included in SMART information of the memory system.

7. The memory system of claim 5, wherein the memory controller is configured to:
in response to determining that the system temperature is less than the first threshold or the speed of data transmission is greater than the second threshold, scan the memory device at the first frequency.

8. The memory system of claim 1, wherein the memory device comprises a plurality of memory blocks, wherein the reliability performance includes a count of consecutive memory blocks which are scanned consecutively and on which garbage collection is performed,
wherein the memory controller is configured to:
in response to determining that the count of consecutive memory blocks is greater than a third threshold, scan the memory device at a third frequency, wherein the third frequency is greater than the first frequency.

9. The memory system of claim 8, wherein the memory controller is configured to:
receive a response corresponding to a scan result of scanning a memory block; and
determine whether the memory block needs garbage collection based on the response.

10. The memory system of claim 9, wherein the response comprises a failed bit count of the memory block.

11. The memory system of claim 8, wherein the garbage collection is performed while there is no data transmission between a host and the memory controller.

12. The memory system of claim 8, wherein the memory controller is configured to:
in response to determining that each of the plurality of memory blocks is scanned, scan the memory device at the first frequency.

13. A method of operating a memory system, comprising:
scanning a memory device of the memory system at a first frequency;
obtaining an operation condition or a reliability performance of the memory device; and
in response to determining that the operation condition or the reliability performance satisfies a criterion, scanning the memory device at a frequency greater than the first frequency.

14. The method of claim 13, wherein scanning the memory device at the first frequency comprises:
sending, at the first frequency, first read commands to read first data from the memory device; and
determining whether the first data are read successfully.

15. The method of claim 13, wherein the operation condition comprises a system temperature of the memory system and a speed of data transmission between a host and the memory system, and wherein the method comprises:
in response to determining that the system temperature is greater than a first threshold and the speed of data transmission is less than a second threshold, scanning the memory device at a second frequency, wherein the second frequency is greater than the first frequency.

16. The method of claim 13, wherein the memory device comprises a plurality of memory blocks, wherein the reliability performance includes a count of consecutive memory blocks which are scanned consecutively and on which garbage collection is performed,
wherein the method comprises:
in response to determining that the count of consecutive memory blocks is greater than a third threshold, scanning the memory device at a third frequency, wherein the third frequency is greater than the first frequency.

17. A memory controller, comprising one or more processors and an interface, wherein the one or more processors are configured to:
send, by the interface to a memory device coupled to the memory controller, first read commands at a first frequency to scan the memory device;
obtain an operation condition or a reliability performance of the memory device; and
in response to determining that the operation condition or the reliability performance satisfies a criterion, send, by the interface to the memory device, second read commands at a second frequency to scan the memory device, wherein the second frequency is greater than the first frequency.

18. The memory controller of claim 17, wherein the operation condition comprises:
a system temperature of a memory system comprising the memory controller and the memory device; and
a speed of data transmission between a host and the memory controller,
wherein the memory controller is configured to:
in response to determining that the system temperature is greater than a first threshold and the speed of data transmission is less than a second threshold, send the second read commands at the second frequency.

19. The memory controller of claim 18, wherein the memory controller is configured to:
in response to determining that the system temperature is less than the first threshold or the speed of data transmission is greater than the second threshold, send the first read commands at the first frequency.

20. The memory controller of claim 17, wherein the memory device comprises a plurality of memory blocks, wherein the reliability performance includes a count of consecutive memory blocks which are scanned consecutively and on which garbage collection is performed,
wherein the memory controller is configured to:
in response to determining that the count of consecutive memory blocks is greater than a third threshold, send third read command at a third frequency to scan the memory device, wherein the third frequency is greater than the first frequency.
